(19) United States
(12) Patent Application Publication
(10) Pub. No.: US 2015/0360786 A1
(43) Pub. Date: Dec. 17, 2015

(54) DEVICE FOR PRECOOLING AND PURIFYING ENGINE BLEED AIR

(71) Applicant: Airbus Defence and Space GmbH, Ottobrunn (DE)

(72) Inventors: Korbinian OBERPRILLER, Kleinhoehenrain (DE); Helmut OBERPRILLER, Kleinhoehenrain (DE)

(21) Appl. No.: 14/737,629

(22) Filed: Jun. 12, 2015

(30) Foreign Application Priority Data
Jun. 13, 2014 (DE) 10 2014 008 411.6

(51) Int. Cl. B64D 13/08

(52) U.S. Cl. CPC B64D 13/08; B64D 2013/0614

(57) ABSTRACT

A cooling device for the cooling of bleed air in an aircraft comprises an inlet opening for letting in bleed air, and an outlet opening for letting out bleed air. Furthermore, the cooling device comprises a heat exchanger with a first surface, along which the bleed air can be led from the inlet opening to the outlet opening, and with a second surface, along which a cooling medium can be led. The first surface comprises a catalytic element and is designed to carry out a catalytic reduction of bleed air impurities. The heat exchanger is a rib plate heat exchanger, and the first surface is at least in part formed by a first rib.

### CROSS-REFERENCE TO RELATED APPLICATION

This application claims the priority to German Patent Application No 10 2014 008 411.6, filed Jun. 13, 2014, which is incorporated herein by reference in its entirety.

### TECHNICAL FIELD

The embodiments relate to a cooling device for the cooling of bleed air and to an aircraft comprising such a cooling device.

### BACKGROUND

In aircraft, in particular in aircraft for the transport of passengers, in operation of such an aircraft, air is taken up from the surroundings of the aircraft and is delivered to the passenger region of the aircraft. The air can, for example, be taken from an engine compressor, thus being called bleed air. The bleed air taken from the engine compressor can have a temperature of between 250 degrees Celsius and above, for example of up to 600 degrees Celsius or 650 degrees Celsius. This air is subsequently fed to a precooler in order to reduce the temperature. At the outlet of the precooler the air can, for example, have been cooled to approximately 200 degrees Celsius. This air flows in pipelines through an airfoil of the aircraft and after further cooling and pressure release is mixed with the air recirculated from the cabin and is subsequently fed into the passenger cabin. Optionally, a filter or a filter element or a converter can be coupled to the pipeline in order to purify the bleed air flowing through the pipeline.

The converter can, in particular, be an ozone/VOC converter. A VOC (volatile organic compounds) converter is used to reduce the presence of volatile organic compounds.

An ozone/VOC converter, which is arranged in the fuselage of an aircraft, that is spatially separate or located spaced apart from the precooler, cannot provide satisfactory filter performance in terms of a reduction in gaseous and particulate organic impurities. This can be because for a reduction in gaseous and particulate organic impurities a comparatively high reaction temperature may be required, or, expressed differently, the reduction rate increases as the temperature of the air increases.

EP 1 499 422 B1 describes a shell-and-pipe heat exchanger or tube bundle heat exchanger with modified pipes, which shell-and-pipe heat exchanger represents a combined system comprising a precooler and an ozone converter. The system described in the aforementioned document is associated with a disadvantage in that it entails very considerable manufacturing effort that as a result of the use of a multitude of individual components is associated with very considerable expenditure. As a result of the installations in the pipes, the pressure loss of the system can increase. A shell-and-pipe heat exchanger may provide insufficient cooling performance for new generations of engines and the associated higher bleed air temperatures.

In addition, other objects, desirable features and characteristics will become apparent from the subsequent summary and detailed description, and the appended claims, taken in conjunction with the accompanying drawings and this background.

### SUMMARY

There may be a need to provide a cooling device for the cooling of bleed air in an aircraft, which cooling device removes undesirable substances from the bleed air with improved efficiency.

According to a first aspect a cooling device for the cooling of bleed air is stated. The cooling device comprises an inlet opening for letting in bleed air, and an outlet opening for letting out bleed air. Furthermore, the cooling device comprises a heat exchanger with a first surface, along which the bleed air can be led from the inlet opening to the outlet opening, and with a second surface, along which a cooling medium can be led. The first surface comprises a catalytic element and is designed to carry out a catalytic reduction of bleed air impurities. The heat exchanger is a rib plate heat exchanger, and the first surface is at least in part formed by a first rib.

Preferably, finely distributed particles of the precious metals platinum and palladium and/or of metal oxides (e.g. manganese oxide, copper(II) oxide on coatings with a high or large internal surface are used as catalytic materials. These coatings usually comprise mixtures of inorganic oxides; they are referred to as washcoats.

The cooling device comprises a heat exchanger that at the same time acts as a catalytic element. In other words, the cooling function and the converter function are thus spatially and functionally combined in one device. A reduction in certain impurities from the bleed air may require a high temperature. In that the catalytic element is spatially arranged on the heat exchanger of the cooling device, in particular on the precooler, a high temperature is provided by the engine bleed air.

The catalytic element can, in particular, be designed to remove ozone, volatile organic compounds and/or particulate organic impurities from the engine bleed air by way of catalytic reduction.

When compared to a shell-and-pipe heat exchanger, a rib plate heat exchanger features higher efficiency in terms of its cooling performance (in other words better cooling performance), but may be associated with heavier weight when compared to a shell-and-pipe heat exchanger. Furthermore, a rib plate heat exchanger may, in particular with equal cooling performance, require less installation space than a shell-and-pipe heat exchanger. Generally speaking, a rib plate heat exchanger features simpler manufacturing because the ribs and the plates can be stacked alternately and can be mechanically coupled to each other. Such mechanical coupling can, for example, take place by sintering.

Rib plate heat exchangers can be designed in any forms and variants. The bleed air and the cooling medium flow through a rib plate heat exchanger so that no mixing between bleed air and cooling medium takes place, i.e. that the bleed air and the cooling medium flow through fluid ducts that are separate from each other. At least part of the surface, or the complete surface, that is in contact or that can come into contact with the bleed air comprises a catalytic element. The material from which the rib plate heat exchanger is manufactured can have a catalytic effect. The composition of the material of the rib plate heat exchanger can be selected so that all the known catalytic elements or materials compositions can be used.

The cooling medium can be any suitable fluid; in particular, air from the surroundings of the cooling device can be used for this purpose; in the use in an aircraft, in particular, air from the atmosphere surrounding the aircraft.

According to one embodiment the first surface comprises a catalytic coating which coats or covers the first surface at least in part or in sections.

In terms of the catalytic coating, in particular in terms of the function of the catalytic coating, analogously the same applies as has already been explained in the context of the catalytic element.

According to a further embodiment the first surface is completely catalytically coated.

The greater the coated area of the first surface the better the filter performance can be, or the longer a required filter performance can be provided. Thus with an increased duration in which a desired filter performance is provided, the service life and the possible operating lifetime of a cooling device are extended.

According to a further embodiment the first surface extends at least in part into a non-cooled section of the cooling device.

In the non-cooled section of the cooling device the temperature is higher than in a cooled section, and consequently the rate of reduction achieved by the catalytic element can be additionally increased as a result of the higher temperature.

According to a further embodiment the non-cooled section of the cooling device is arranged so that the non-cooled section in a direction of flow of the bleed air follows on from the inlet opening of the cooling device.

Starting from a bleed point of the bleed air in an engine compressor the non-cooled bleed air moves through the inlet opening into the cooling device and at this position reaches its highest temperature. Thus at the point of its highest temperature in the cooling device the bleed air encounters the first surface, which in this region makes it possible to achieve a high rate of reduction or the maximum rate of reduction.

According to a further embodiment a cooled section of the cooling device is arranged between the non-cooled section and the outlet opening of the cooling device.

This combination of non-cooled section and cooled section makes it possible on the one hand to achieve the highest possible rate of reduction of impurities from the bleed air, and on the other hand to achieve cooling of the bleed air.

According to a further aspect an aircraft with a cooling device as described above and below is stated. The inlet opening of the cooling device is coupled to a bleed point in order to take up bleed air.

Thus the bleed air is fed from the bleed point to the cooling device, which carries out both the function of cooling and the function of reducing undesirable substances from the bleed air.

According to one embodiment the bleed point is a compressor that is arranged on an engine of the aircraft.

By way of a fluid connection the inlet opening of the cooling device is coupled directly to the bleed point. Between the engine compressor and the precooler pressure regulating valves can be arranged that among other things reduce the pressure of approximately 10 bar in the engine compressor to approximately 3 bar (absolute).

Normally the engine compressor forms part of the engine and is used primarily for compressing the air prior to injection of the fuel into the combustion chamber. A small part of the compressed air (a few percent) is bled from the compressor (from a medium-pressure or high-pressure stage of the engine compressor); it is used to supply cabin air. The compressor is usually located in the engine.

According to a further embodiment the cooling device is arranged between an engine and an airfoil of the aircraft.

The cooling device as described above and below combines the cooling of bleed air with the reduction of undesirable substances from the bleed air in one device and can thus improve the quality of the air provided in a passenger compartment of an aircraft. In particular, it may no longer be necessary to have to optionally provide a filter in the form of an ozone/VOC converter in the aircraft fuselage.

The rib plate heat exchanger or finned plate heat exchanger can be designed in any geometric shape, e.g. angular, round, oval, and can, for example, be designed as a honeycomb structure or a finned heat exchanger. The complete surface or parts or sections of the surface through which the bleed air flows, or which comes into contact with the bleed air, comprises catalytic material or is catalytically coated. In the case of coating, the ribs and plates of the heat exchanger can comprise different or identical coating; the coating can change as the direction of travel, i.e. the direction of flow of the bleed air through the heat exchanger, changes, and can comprise different compositions in different zones of the heat exchanger. The rib plate heat exchanger can be made from any materials suitable for this purpose, e.g. from aluminum, steel, titanium or alloys thereof, and is not restricted to a particular manufacturing process. The heat exchanger can be a cross-current heat exchanger, a counter-current heat exchanger or a co-current heat exchanger. Heat transfer from gas to gas or from gas to a liquid is possible. This means that the bleed air and the cooling medium are a fluid. The ribs can have any suitable geometric shape, and the arrangement, position, shape and number of ribs can vary. Furthermore, the thickness of the ribs can vary. The ribs can comprise recesses in the form of perforations or holes or indentations. The recesses can, in particular, be designed to create turbulence in the flowing bleed air so that the bleed air establishes contact with the first surface. As is the case with the ribs, the plates, too, can comprise any possible and suitable geometric shape. The number of plates and the spacing between adjacent plates relative to each other can vary. The inlet opening for the bleed air and an inlet opening for the cooling medium can in each case be designed freely in terms of their form and function (with/without turbulence element, nozzle/diffuser, inflow distribution).

In all probability, ozone/VOC converters will be part of standard equipment in future aircraft generations. The combination solution described in this document can provide a significant reduction in weight and can also reduce flow resistance in that only a single device (the cooling device) is provided that as a result of the catalytic coating becomes only marginally heavier, rather than two spatially separate devices, namely and ozone/VOC converter and a precooler.

### BRIEF DESCRIPTION OF THE DRAWINGS

The various embodiments will hereinafter be described in conjunction with the following drawing figures, wherein like numerals denote like elements, and:

FIG. 1 diagrammatic view of a cooling device in an installed state on an aircraft according to one exemplary embodiment.

FIG. 2 diagrammatic view of a cooling device according to a further exemplary embodiment.

FIG. 3 diagrammatic view of a rib plate heat exchanger for a cooling device according to a further exemplary embodiment.

### DETAILED DESCRIPTION

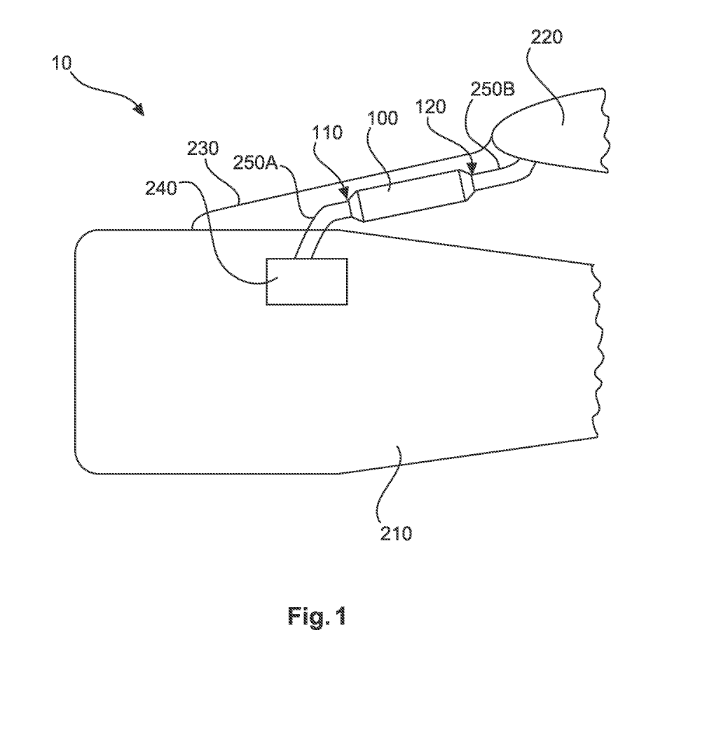

FIG. 1 shows a diagrammatic partial view of an aircraft 10. The aircraft comprises an engine 210 and an airfoil 220, wherein the engine 210 is mechanically coupled, by means of a coupling element 230, to the airfoil 220. On or in the engine 210 a bleed point 240 is arranged. The bleed point can, in particular, be a compressor that also provides air for the engine.

The cooling device 100 is arranged between the engine 210 and the airfoil 220. In this design an inlet opening 110 of the cooling device is coupled, by means of a gas guiding element 250A in the form of a tube, to the bleed point 240 so that a flow of the bleed air starting from the bleed point 240 to the cooling device 100 can take place. An outlet opening 120 of the cooling device 100 is coupled, by way of a second gas guiding element 250B in the form of a tube, to a pipe bundle (not shown) in the airfoil 220 so that the bleed air starting from the outlet opening 120 can be fed to a passenger region of the aircraft 10.

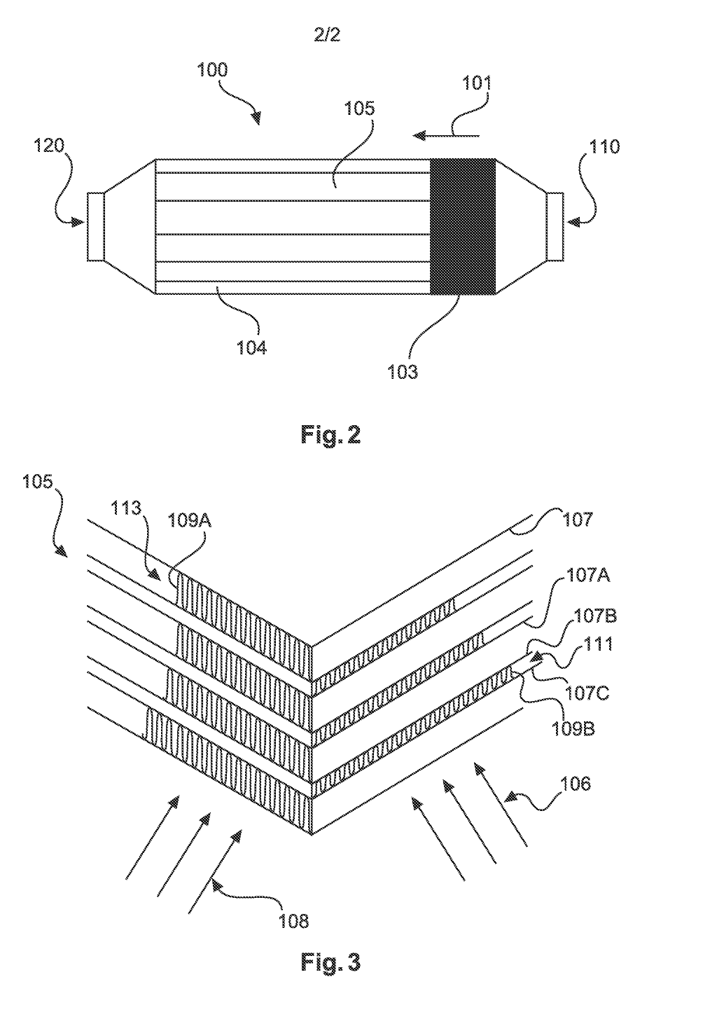

FIG. 2 shows a diagrammatic view of a cooling device 100. The bleed air flows from the inlet opening 110 through the heat exchanger 105 in the form of a rib plate heat exchanger to the outlet opening 120 in the direction of the arrow 101 that shows the direction of flow of the bleed air.

In this exemplary embodiment the bleed air first flows through a first, non-cooled, section 103 of the cooling device 100 before a second, cooled, section 104 of the cooling device 100 is subjected to the flow of the bleed air. In the non-cooled region 103, which can be referred to as the first longitudinal section, no active cooling of the bleed air takes place in order to in this longitudinal section 103 achieve a high rate of reduction in undesirable substances contained in the bleed air.

The non-cooled first longitudinal section 103 can, in particular, be designed so that in this longitudinal section a coolant does not enter the heat exchanger, or that the heat exchanger in this longitudinal section 103 does not comprise any coolant ducts through which a coolant can flow.

FIG. 3 shows a diagrammatic view of a rib plate heat exchanger 105 for a cooling device 100 according to one exemplary embodiment. The rib plate heat exchanger 105 comprises several layers that alternately are designed as plates or as ribs. In each case ribs 109A, 109B are arranged between adjacent plates 107. In each case the ribs 109A, 109B form ducts through which the bleed air 106 or the cooling medium 108 can flow along the surface of the particular rib.

The rib plate heat exchanger in FIG. 3 is designed as a cross-current heat exchanger. This means that the directions of flow of the bleed air 106 and of the cooling medium 108 extend at an angle to each other, i.e. they intersect. In the example of FIG. 3 these two directions of flow essentially extend perpendicularly to each other.

Respectively adjacent spaces formed by the plates are alternately open or closed to the bleed air 106 or to the cooling medium 108. Thus, for example, no bleed air can enter the space between the plates 107A, 107B, whereas bleed air can enter the adjacent space between the plates 107B, 107C. In the case of the cooling medium 108 this situation is reversed so that the cooling medium and the bleed air cannot mix.

The surface of the ribs and plates along which surface the bleed air can flow is referred to as the first surface 111, whereas the surface of the ribs and plates that is in contact with the cooling medium is referred to as the second surface 113.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the embodiment in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the embodiment as set forth in the appended claims and their legal equivalents.

What is claimed is:

1. A cooling device for the cooling of bleed air in an aircraft, comprising:
an inlet opening for letting in bleed air, and an outlet opening for letting out bleed air;
a heat exchanger with a first surface, along which the bleed air can be led from the inlet opening to the outlet opening, and with a second surface, along which a cooling medium can be led;
wherein the first surface comprises a catalytic element and is designed to carry out a catalytic reduction of bleed air impurities;
wherein the heat exchanger is a rib plate heat exchanger, and the first surface is at least in part formed by a first rib.

2. The cooling device of claim 1,
wherein the first surface comprises a catalytic coating which coats the first surface at least in part.

3. The cooling device of claim 1,
wherein the first surface comprises a catalytic coating which completely coats the first surface.

4. The cooling device according to claim 1,
wherein the first surface extends at least in part into a non-cooled section of the cooling device.

5. The cooling device of claim 4,
wherein the non-cooled section of the cooling device is arranged so that the non-cooled section in a direction of flow of the bleed air follows on from the inlet opening of the cooling device.

6. The cooling device of claim 4,
wherein a cooled section is arranged between the non-cooled section and the outlet opening of the cooling device.

7. An aircraft comprising a cooling device for the cooling of bleed air, the cooling device comprising:
an inlet opening for letting in bleed air, and an outlet opening for letting out bleed air;
a heat exchanger with a first surface, along which the bleed air can be led from the inlet opening to the outlet opening, and with a second surface, along which a cooling medium can be led;
wherein the first surface comprises a catalytic element and is designed to carry out a catalytic reduction of bleed air impurities;
wherein the heat exchanger is a rib plate heat exchanger, and the first surface is at least in part formed by a first rib;
wherein the inlet opening of the cooling device is coupled to a bleed point in order to take up bleed air.

8. The aircraft of claim 7,
wherein the bleed point is a compressor that is arranged on an engine of the aircraft.

9. The aircraft of claim 7,
wherein the cooling device is arranged between an engine and an airfoil.
